(19) United States
(12) Patent Application Publication
(10) Pub. No.: US 2023/0173492 A1
(43) Pub. Date: Jun. 8, 2023

(54) CONSUMABLE MICROFLUIDIC DEVICE

(71) Applicant: Hewlett-Packard Development Company, L.P., Spring, TX (US)

(72) Inventors: Napoleon J. Leoni, Palo Alto, CA (US); Omer Gila, Palo Alto, CA (US)

(73) Assignee: Hewlett-Packard Development Company, L.P., Spring, TX (US)

(21) Appl. No.: 17/927,674

(22) PCT Filed: May 29, 2020
(86) PCT No.: PCT/US2020/035375

§ 371 Date: Nov. 23, 2022

(51) Int. Cl. B01L 3/00

(52) U.S. Cl. CPC B01L 3/502792; B01L 2400/0427

(57) ABSTRACT

A consumable microfluidic receptacle includes a first sheet and a second sheet. The first sheet is electrically connectable to a ground element. The second sheet is spaced apart from the first plate, wherein the microfluidic receptacle is to receive a liquid droplet between the first and second sheets. The second sheet includes an exterior surface portion to receive releasable contact from an array of individually controllable electrodes of an electrode control element to produce an electric field from the second sheet to the first sheet to selectively pull the liquid droplet through the microfluidic receptacle. The second sheet comprises a conductive-resistant matrix and a plurality of conductive paths spaced apart throughout the matrix and oriented perpendicular to a plane through which second sheet extends.

### BACKGROUND

Microfluidic devices are revolutionizing testing in the healthcare industry. Some microfluidic devices comprise digital microfluidic technology, which may employ circuitry to move fluids.

### BRIEF DESCRIPTION OF THE DRAWINGS

FIGS. 1A and 1B each are a diagram including a side view schematically representing an example arrangement and/or example method including a consumable microfluidic device to receive releasable contact from an electrode control element.

FIG. 1C is a diagram including a side view schematically representing a conductive element comprising an elongate pattern of conductive particles.

FIG. 2 is a diagram including a top view schematically representing an example consumable microfluidic device.

FIG. 3A is a diagram including an isometric view schematically representing an example two-dimensional array of individually controllable electrodes, prior to releasable contact relative to, a portion of a consumable microfluidic receptacle.

FIG. 3B is a diagram including a top view schematically representing an example two-dimensional array of individually controllable electrodes.

FIG. 4 is a diagram including a side view schematically representing an example consumable microfluidic receptacle including a coating to facilitate movement of liquid droplets.

FIG. 5A is a diagram including a side view schematically representing an example consumable microfluidic receptacle including an anisotropic conductivity layer including a rigid first portion and a compliant second portion.

FIG. 5B is a diagram including a side view schematically representing an example consumable microfluidic receptacle comprising a layer including an anisotropicly conductive, rigid first portion and a releasable adhesive, compliant second portion.

FIGS. 6A-6D are a series of diagrams, each including a side view schematically representing an example device and/or example method of controlling movement of liquid droplets.

FIG. 7A is a block diagram schematically representing an example fluid operations engine.

FIG. 7B is a block diagram schematically representing an example control portion.

FIG. 7C is a block diagram schematically representing an example user interface.

FIG. 8 is a flow diagram schematically representing an example method of causing, via an electrical field, movement of droplets.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure are directed to providing a consumable microfluidic receptacle by which digital microfluidic operations can be performed in an inexpensive manner. In some examples, an electrode control element may be brought into releasable contact against a plate of the consumable microfluidic receptacle, whereby the electrode control element is to externally apply charges to cause an electric field through the plate which induces movement of a droplet within and through the microfluidic receptacle. In some such examples, the movement comprises an electrowetting-based movement. In one aspect, “charges” as used herein refers to ions (+/−) or free electrons. In some examples, the plate may sometimes be referred to as a sheet, a wall, a portion, and the like. Moreover, in some examples, the consumable microfluidic receptacle may form part of and/or comprise a microfluidic device. In some examples, the consumable microfluidic receptacle may sometimes be referred to as a single use microfluidic receptacle, or as being a disposable microfluidic receptacle.

In some examples, each droplet comprises a small, single generally spherical mass of fluid, such as may be dropped into the consumable microfluidic receptacle. As described above, the entire droplet is sized and shaped to be movable via electrowetting forces. In sharp contrast, dielectrophoresis may cause movement of particles within a fluid, rather than movement of an entire droplet of fluid. Some further example details are provided below.

In some examples, the electrode control element comprises an array of individually controllable electrodes, and as such sometimes may be referred to as an addressable electrode control element. In some examples, the array may comprise a two-dimensional array of individually controllable electrodes.

In some examples, the addressable electrode control element may apply charges having a first polarity and/or an opposite second polarity in order to build charges on the plate. The first polarity may be positive or negative depending on the particular goals for manipulating a droplet, while the second polarity will be the opposite of the first polarity. In some examples, the addressable control element may cause an electrode(s) to be at ground (e.g. 0 Volts) to neutralize charges, as desired, as part of controlling movement of a droplet.

In some examples, the controlled movement of droplets may occur between adjacent target positions along passageways within a microfluidic receptacle of a microfluidic device. In some such examples, the respective target positions correspond to locations at which the charges are directed from the respective individually controllable electrodes of the electrode control element.

In some examples, in view of the addressability (e.g. individual control) of the electrodes with respect to the target locations of the consumable microfluidic receptacle, the consumable microfluidic receptacle may sometimes be referred to as a digital microfluidic receptacle or device.

In some examples, a plate of the consumable microfluidic receptacle, through which the addressable electrode control element externally applies charges, may comprise anisotropic conductivity to facilitate rapid transfer of the charges to an interior surface portion of the plate. This arrangement, in turn, may facilitate faster execution of microfluidic operations while mitigating dissipation of the externally-applied charges as they pass through the plate. In some examples, the anisotropic conductivity also may increase the pulling forces on the droplet.

Via such example arrangements, the consumable microfluidic receptacle may omit control electrodes which might otherwise be used to cause microfluidic operations such as moving, merging, and/or splitting droplets within a microfluidic device. Moreover, by providing the releasable contact, addressable electrode control element to cause an electric field on a portion of the consumable microfluidic receptacle, the consumable microfluidic receptacle may omit inclusion of a printed circuit board and circuitry associated with some digital microfluidic devices. This arrangement may significantly reduce the cost of the consumable microfluidic receptacle of the microfluidic device and/or significantly ease its disposal, recyclability, and the like. By being able to re-use the releasable contact, addressable electrode control element over-and-over again with a supply of disposable or consumable microfluidic receptacles, this example arrangement greatly reduces the overall, long term cost of using digital microfluidic devices while significantly conserving valuable electrically conductive materials.

In some examples, the consumable microfluidic receptacle may be used to perform microfluidic operations to implement a lateral flow assay and therefore may sometimes be referred to as a lateral flow device. In some examples, the consumable microfluidic receptacle also may be used for other types of devices, tests, assays which rely on or include digital microfluidic operations, such as moving, merging, splitting, etc. of droplets within internal passages within the microfluidic device.

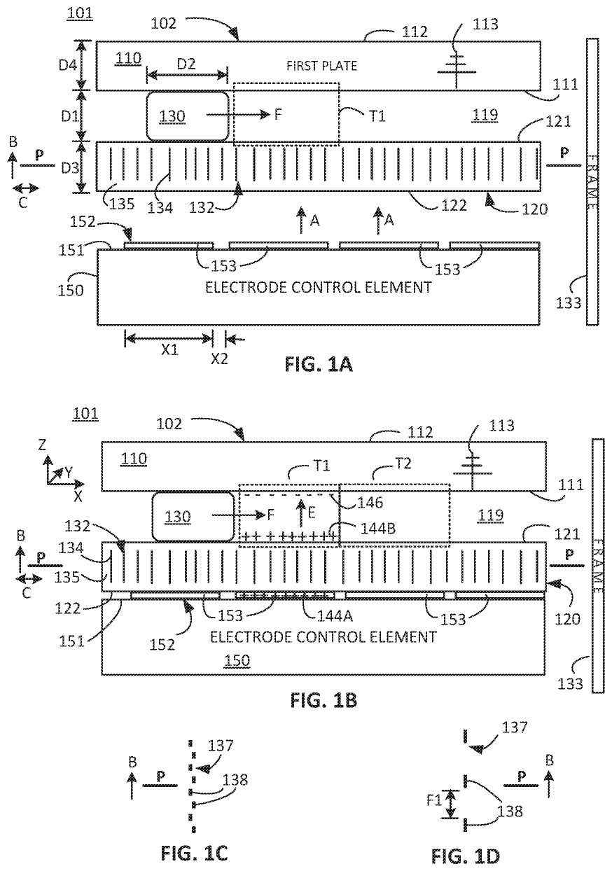

These examples, and additional examples, are further described and illustrated below in association with at least FIGS. 1A-8.

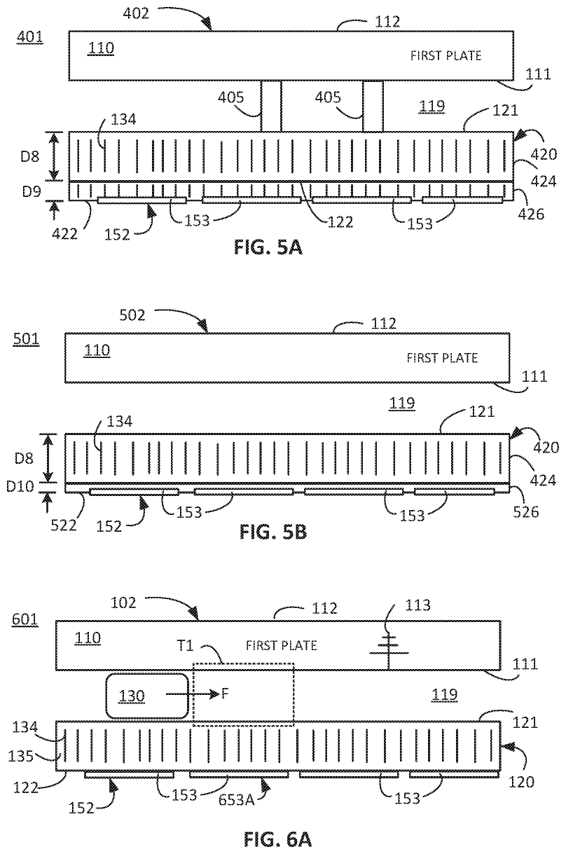

FIG. 1A is a diagram including a side view schematically representing an example microfluidic arrangement 101 (and/or example method) to control droplet movement via external application of charges. In some examples, the arrangement 101 may comprise a consumable microfluidic receptacle 102 and a releasable contact, electrode control element 150, either of which may be provided separately. As shown in FIG. 1A, the consumable microfluidic receptacle 102 comprises a first plate 110 and a second plate 120 spaced apart from the first plate 110, with the spacing between the respective plates 110, 120 sized to receive and allow movement of a liquid droplet 130. In some examples, the consumable microfluidic receptacle 102 may form a portion of a microfluidic device, and according sometimes may be referred to as a microfluidic device or portion thereof. While not shown for illustrative simplicity, it will be understood that the consumable microfluidic receptacle 102 may comprise spacer elements at periodic or non-periodic locations between the first plate 110 and the second plate 120 to maintain the desired spacing between the respective plates 110,120 and/or to provide structural integrity to the microfluidic receptacle 102 and second plate 120. The example consumable microfluidic receptacle 402 later shown in FIG. 5A provides example spacer element(s) 405.

As shown in FIG. 1A, in some examples each of the respective first and second plates 110 and 120 comprises an interior surface 111, 121, respectively, and each of the respective first and second plates 110, 120 comprise an exterior surface 112, 122, respectively. The respective interior and exterior surfaces may sometimes be referred to as interior surface portions and exterior surface portions, respectively.

In some examples, at least the interior surface 111, 121 of the respective plates 110, 120 may comprise a planar or substantially planar surface. However, it will be understood that the passageway 119 defined between the respective first and second plates 110, 120 may comprise side walls, which are omitted for illustrative simplicity. The passageway 119 may sometimes be referred to as a conduit, cavity, and the like. With this in mind, the consumable microfluidic receptacle may sometimes be referred to as a consumable microfluidic cavity.

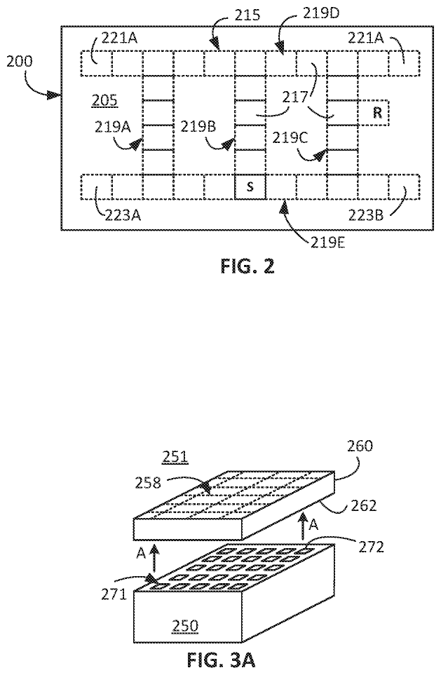

It will be understood that the first and second plates 110, 120 may form part of, and/or be located within, a housing, such as the housing 205 of the microfluidic device 200 (e.g. a consumable microfluidic receptacle) shown in FIG. 2.

In some examples, the interior of the passageway 119 (between plates 110, 120) may comprise a filler such as a dielectric oil, while in some examples, the filler may comprise air. In some such examples, the filler may comprise other liquids which are immiscible and/or which are electrically passive relative to the droplet 130 and/or relative to the respective plates 110, 120. In some examples, the filler may affect the pulling forces (F), may resist droplet evaporation, and/or facilitate sliding of the droplet and maintaining droplet integrity.

In some examples, the distance (D1) between the respective plates 110, 120 may comprise between about 50 micrometers to about 1000 micrometers, between about 100 to about 500 micrometers, or about 200 micrometers. In some examples, the droplet 130 may comprise a volume of between about 10 picoliters and about 30 microliters. However, it will be understood that in some examples, the consumable microfluidic device 102 is not strictly limited to such example volumes or dimensions.

In some examples, as shown in FIG. 1A, each electrode 153 may comprise a length (X1) which may comprise a length expected to be approximately the same size as the droplet 130 to be moved. In view of the example volumes of droplets noted above, the length (X1) of each electrode 153 may comprise between about 50 micrometers to about 5 millimeters, and may comprise a width similar to its length in some examples. At least some further examples are provided later in association with at least FIG. 2 in the context of the length (X1) of each electrode 153 being commensurate with the length (D2) of a droplet or target position (e.g. T1, T2) of a droplet within the consumable microfluidic receptacle 102.

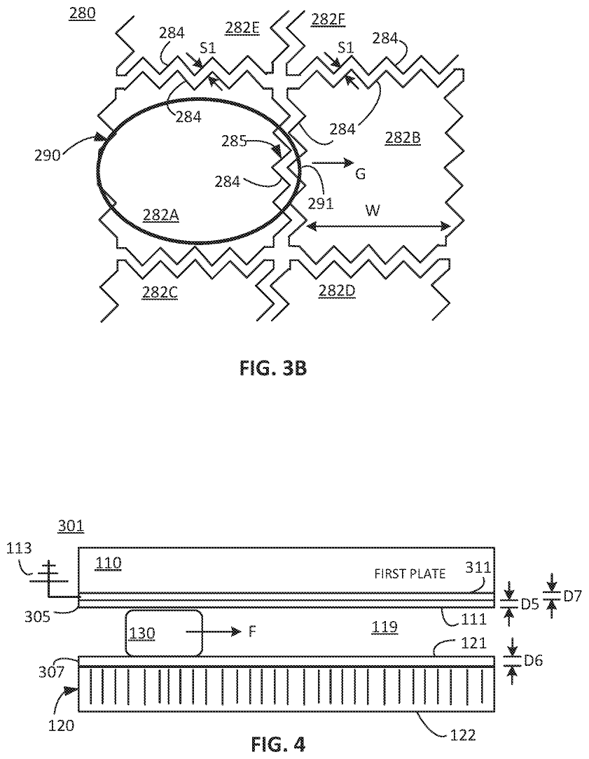

In some examples, the length (D2) of the droplet in passageway 119 may sometimes be referred as a length scale of the droplet, or a length of a target position of a droplet. Meanwhile, the distance (X2) between adjacent electrodes 153 may sometimes be referred to as the length scale of the electrodes 153. In some examples, as later described in more detail in association with at least FIG. 3B, the length scale (X2) between electrodes 153 may comprise about 50 to about 75 micrometers (e.g. 2-3 mils) and also may sometimes be referred to as spacing (S1 in FIG. 3B) between electrodes 153.

In some examples, the above-described example arrangement of the present disclosure stands in sharp contrast to some microfluidic devices which rely on dielectrophoresis to produce movement. At least some such dielectrophoretic devices comprise a distance between control electrodes (of a printed circuit board which form one of the microfluidic plates) which is substantially greater (e.g. 10 times, 100 times, etc.) than a length scale (e.g. size) of a particle within a liquid to be moved. For example, the distance between control electrodes (in some dielectrophoretic devices) may be on the order of hundreds (i.e. 100's) of micrometers, whereas the length scale of such particles may comprise on the order of hundreds (i.e. 100's) nanometers. In some such examples, the distance between electrodes in a dielectrophoretic device may sometimes be referred to as a length scale of such electrodes or as a length scale of the gradient (i.e. gradient length scale).

For comparison purposes to some dielectrophoretic devices, a droplet of liquid to be moved via electrowetting forces in at least some examples of the present disclosure may comprise a thickness between a first plate 110 and second plate 120 of about 200 micrometers, and a length (or width) extending across an electrode (e.g. 153) of about 2 millimeters, in some examples. In sharp contrast, dielectrophoresis may cause movement of a particle within a mass of fluid, where such particle may be about 100 nanometers diameter (or length, width, or the like) and many particles may reside within a droplet of liquid. However, the dielectrophoretic device does not generally cause movement of an entire fluid mass.

In some examples, the first plate 110 may be grounded, i.e. electrically connected to a ground element 113. In some examples, the first plate 110 may comprise a thickness (D4) of about 100 micrometers to about 3 millimeters, and may comprise a plastic or polymer material. In some examples, the first plate 100 may comprise a glass-coated, indium tin oxide (ITO). As noted later in association with at least FIG. 2, the thickness (D4) may be selected to accommodate fluid inlets (e.g. 221A, 223A, etc. in FIG. 2), to house and/or integrate sensors into the first plate 110, and/or to provide structural strength. In some examples, the sensors may sense properties of the fluid droplets, among other information.

In some examples, the second plate 120 may comprise an anisotropic conductivity arrangement (e.g. configuration) comprising a conductive-resistant medium 135 (e.g. partially conductive matrix) within which an array 132 of conductive elements 134 is oriented generally perpendicular to the plane (P) through which the second plate 120 generally extends. In some examples, the conductive-resistant medium 135 (e.g. matrix) may comprise a bulk resistivity of about 10¹¹ Ohm-cm to about 10¹⁶ Ohm-cm. In some such examples, the conductive elements 134 may comprise a conductivity at least two orders of magnitude greater than a bulk conductivity of the conductive-resistant medium 135. In some examples, the resistant-conductive medium 135 of the second plate 120 may comprise a plastic or polymeric materials, such as but not limited to, materials such as polypropylene, Nylon, polystyrene, polycarbonate, polyurethane, epoxies, or other plastic materials which are low cost and available in a wide range of conductivities. In some examples, a bulk conductivity (or bulk resistivity) within the desired range noted above may be implemented via mixing into the plastic material some conductive carbon molecules, carbon black pigments, carbon fibers, or carbon black crystal.

In some examples, the conductive-resistant medium 135 may comprise a resistivity of less than 10⁹ Ohm-cm in the perpendicular direction (arrow B) to P plane, and a larger lateral resistivity (e.g. lateral conductivity) of at least 10¹¹ Ohm-cm, such as represented via arrow C. Accordingly, the lateral conductivity (arrow C) is at least two orders of magnitude greater than the conductivity of the conductive-resistant medium 135 in the direction (arrow B) perpendicular to the plane P (FIG. 1B).

In some examples, the relative permittivity of the conductive-resistant medium 135 of second plate 120 may be greater than about 20. In some examples, the relative permittivity may be greater than about 25, 30, 35, 40, 45 50, 55, 60, 65, 70, or 75. In some instances, the relative permittivity may sometimes be referred to as a dielectric constant. Among other attributes, providing such relative permittivity may result in a lower voltage drop for the electrodes 153 (of the control element 150) across the second plate 120. In some examples, the relative permittivity of the second plate 120 in the direction of the plane P may comprise lower than about 10. In some examples, it may comprise about 3.

As noted above, in some examples, the second plate 120 may comprise a low lateral conductivity (i.e. a conductivity along the plane P, such as represented via directional arrow C) with resistivity of at least 10¹¹ Ohm-cm (similar to the bulk conductivity). In some examples, this resistivity along the plane P (i.e. lateral conductivity) may comprise about 10¹⁴ Ohm-cm.

In some examples, the second plate 120 may comprise a high conductivity perpendicular (arrow B) to the plane P, such as a resistivity which is on the order of, or less than, 10⁹ Ohm-cm. In some examples, this resistivity may comprise 10⁶ Ohm-cm. In at least some examples, the resistivity perpendicular to the plane P is at least about two orders of magnitude different from (e.g. lower) than the resistively along or parallel to the plane P. In some such examples, this relatively high conductivity perpendicular to the plane P may sometimes be referred to as vertical conductivity with respect to the plane P.

In comparison to the relatively high conductivity of the conductive resistant medium 135 perpendicular (direction B) to the plane P, the above-noted relatively low lateral conductivity (direction C) of the conductive resistant medium 135 may effectively force travel of the charges (applied by each respective electrode 153 as further described below) to travel primarily in a direction (B) perpendicular to the plane P, such that the electric field E acting within the passageway 119 (i.e. conduit) 119 may comprise an area (e.g. x-y dimensions) which are similar to the area (e.g. x-y dimensions) of each respective electrode 153.

In some examples, exterior surface 122 of second plate 120, and a first surface 151 of the control element 150 (including a top surface 153) are each planarized to facilitate establishing robust mechanical and electrical connectivity when brought and maintained in releasable contact together.

As shown in FIGS. 1A-1B, via the example anisotropic conductivity arrangement within the second plate 120, the conductive elements 134 are aligned generally parallel to each other, in a spaced apart relationship, in an orientation generally the same as the direction which the charges 144A at the exterior surface 122 (of second plate 120) are to travel through second plate 120 to reach the interior surface 121 of the second plate 120. While the respective conductive elements 134 are shown as being oriented perpendicular to the plane P, it will be understood that in some examples the conductive elements 134 may be oriented at a slight angle (i.e. slanted) which not strictly perpendicular.

Moreover, in some examples, as shown in FIG. 1C, each respective conductive element 134 may comprise an array 137 of smaller conductive particles 138 which are aligned in an elongate pattern to approximate a linear element of the type shown as element 134 in FIGS. 1A-1B. The array 137 of elements 138 may sometimes be referred to as a conductive path. In some examples, the conductive particles 138 may comprise a metal beads ranging from 0.5 micrometers to about 5 micrometers in diameter (or a greatest cross-sectional dimension). In some such examples, these smaller conductive particles may be aligned during formation of the anisotropic layer via application of a magnetic field until the materials (e.g. conductive particles, conductive-resistant medium) solidify into their final form approximating the configuration shown in FIGS. 1A-1B. In contrast to the bulk resistivity of the conductive-resistant medium 135 of a resistivity of at least on the order of 10¹¹ Ohm-cm, the elongate pattern formed by array 137 of conductive particles 138 may comprise a resistivity on the order of 10⁹ Ohm-cm or less in some examples. In some examples, the conductive particles 138 may comprise conductive materials, such as but not limited to iron or nickel. In some examples in which the conductive particles 138 are not in contact with each other, such particles 138 may be spaced apart by a distance F1 as shown in FIG. 1D, with such distances being on the order of a few nanometers. In some examples, the material (e.g. polymer) forming the conductive-resistant medium 135 of the second plate 120 is interposed between the respective conductive particles 138 of the array 137 (e.g. forming the elongate pattern) defining elements 134. In some such examples, because of this very small dimension F1 between at least some of the conductive particles 138, the conductive-resistance medium 135 interposed between the conductive particles 138 (and which would otherwise exhibit a resistivity of at least on the order of 10¹¹ Ohm-cm in some examples) may comprise a conductive bridge (between adjacent particles 138) having a length less than about a micrometer and as such, may exhibit a much smaller resistivity which is several (e.g. 2, 3, or 4) orders of magnitude less than the resistivity otherwise exhibited by the conductive-resistant medium 135. Accordingly, even when some conductive resistant medium 135 is interspersed between some of the aligned conductive particles 138, the elongate pattern (e.g. array 137) of the conductive particles 138 still exhibits an overall conductivity perpendicular to the plane P (through which the second plate 120 extends) which comprises at least two orders of magnitude higher (e.g. greater) than the lateral conductivity along the plane P.

As shown in FIG. 1B, in some examples the addressable electrode control element 150 may be brought into releasable contact against the exterior surface 122 of the second plate 120 of the example consumable microfluidic receptacle 102. In some such examples, the addressable electrode control element 150 may be supported by or within a frame 133 and the consumable microfluidic receptacle 102 may be releasably supportable by the frame 133 to place the consumable microfluidic receptacle 102 and the addressable charge depositing unit 140 into releasable contact and charging relation to each other.

As further shown in FIG. 1B, upon the addressable electrode control element 150 being brought into releasable contact against the consumable microfluidic receptacle 102, a selected electrode(s) 153A of the addressable electrode control element 150 may apply charges directly onto the exterior surface 122 of the second plate 120, which may then be referred to as deposited charges 144A. As further shown in FIG. 1B, the electrode 153A selected from array 152 is aligned with a target position T1 (represented via dashed lines), which is immediately adjacent to the droplet 130 and to which the droplet 130 is to be moved.

With first plate 110 being grounded, counter negative charges 146 develop on surface 111 of the first plate 110 to cause an electric field (E) between the respective first and second plates 110, 120, which creates a pulling force (F) to draw the droplet 130 forward into the target position T1. With the presence of the counter charges 146 at first plate 110, the deposited charges 144A may quickly advance from the exterior surface 122 to the interior surface 121 of the second plate 120.

In some examples, the pulling force (F), which causes movement of droplet 130 upon inducing the electric field (E), may comprise electrowetting forces. In some such examples, the electrowetting forces may result from: (1) modification of the wetting properties of the interior surface 121 of second plate 120 and/or interior surface 111 of plate 110 upon application of the electric field (E); (2) counter charges introduced in the droplet 130, which may result from electrical conductivity within the droplet 130 in some examples and/or from induced dielectric charges within the droplet 130 in some examples; and/or (3) a minimization of the potential energy of the system including the electric field (E) between the counter charges 146 (e.g. negative) and the charges 144A (144B) (e.g. positive).

Depending on the electrical properties of the second plate 120, charges 144A may partially move, or completely move, towards counter charges 146 to become present at the location 144B on surface 121, as shown in FIG. 1B.

In some examples, the deposited charges 144A at second plate 120 may comprise between on the order of tens of volts and on the order of a few hundred volts of charges on the second plate 120. In some examples, the deposited charges 144A may comprise 1000 Volts. It will be understood that the deposited charges 144A will dissipate, e.g. discharge, over time by flowing to the ground 113 and/or by the selected electrode 153A being set to ground (e.g. 0 Volts). In particular, in some examples the deposited charges 144A may be discharged at a rate that is slower than the movement of the liquid droplet 130 (which is on the order of milliseconds) but faster than the next application of charges by electrode control element 150, which may comprise on the order of tens of milliseconds, depending on the particular type of electrode control element 150 and the response time of the second plate 120. As the droplet 130 moves into the area of the charges (i.e. the target position T1), the electric field E drops due to an increased dielectric constant occurring in the effective capacitor which is formed between the respective first and second plates 110, 120, and in some examples because of leakage through the droplet 130 to ground via the first plate 110.

In some examples, because of the anisotropic conductivity arrangement within the second plate 120, the second plate 120 exhibits a response time which is substantially faster than if the second plate 120 were otherwise made primarily or solely of a dielectric material or made of a partially conductive material without the conductive elements 134. Moreover, via at least some such example arrangements, the charges (e.g. 144B) dissipate over time (i.e. discharge) through the droplet 130 instead of primarily discharging through the second plate 120.

In one aspect, the anisotropic conductivity configuration of second plate 120 either may enable faster electrowetting movement of droplets 130 through passageway 119 due to higher electrical field on the droplet resulting in higher pulling forces and/or may permit use of thicker second plates 120, as desired (i.e. increasing the thickness of second plate 120). In one aspect, providing a relative thick/thicker second plate 120 enables better structure strength, integrity and better mechanical control of the gap between interior surface 111 of first plate 110 and interior surface 121 of second plate 120. In some examples, the second plate 120 may comprise a thickness (D3) of about 30 micrometers to about 1000 micrometers. In some examples, the thickness (D3) may comprise about 30 micrometers to about 500 micrometers. In some examples, the second plate 120 may sometimes be referred to as a charge-receiving layer and sometimes may be referred to as an anisotropic conductivity layer.

In one aspect, the anisotropic conductivity configuration of second plate 120 stands in sharp contrast to at least some anisotropic conductive films (ACF) which may resemble a tape structure and involve the application of high heat and high pressure, which in turn may negatively affect the overall structure of the consumable microfluidic receptacle, such as but not limited to, any sensitive sensor elements or circuitry within the first plate 110. Moreover, at least some anisotropic conductive films (ACF) may be relatively thin and/or flexible such that they are unsuitable to stand alone as a bottom plate of a microfluidic device because they may lack sufficient structural strength and durability.

In some examples, the addressable electrode control element 150 also may be used to neutralize charges on second plate 120 so as to prepare the microfluidic receptacle 102 to receive an application of fresh charges from electrode control element in preparation of causing further controlled pulling movement of the droplet 130 to a next target position (e.g. T2).

It will be further understood that charges (e.g. 144A) applied on the second plate 120 (by the electrode control element 150) will be significantly discharged or at least be discharged to a level at which their voltage is significantly lower than the voltage to be applied before the next electrowetting-caused pulling movement of the droplet 130 occurs to the next target position T2.

In some examples, the second plate 120 may comprise a transparent material.

In some examples, both of the addressable electrode control element 150 and the consumable microfluidic receptacle 102 are stationary during microfluidic operations, with the addressable electrode control element 150 being arranged in a two-dimensional array to apply charges in any desired target location (e.g. 217 in FIG. 2) of the microfluidic receptacle in order to perform a particular microfluidic operation or sequence of microfluidic operations. One example implementation of a two-dimensional array of such electrodes is described later in association with at least FIGS. 3A-3B.

However, it will be understood that in some examples, the electrode control element 150 may be mobile and the consumable microfluidic receptacle 102 may be stationary while performing microfluidic operations, while in some examples, the addressable electrode control element 150 may be stationary and the consumable microfluidic receptacle 102 is moved relative to the addressable electrode control element 150 during microfluidic operations. In some examples, the frame 133 (FIG. 1A) may include portions, mechanisms, etc. which may facilitate relative movement between the consumable microfluidic receptacle 102 and the electrode control element 150.

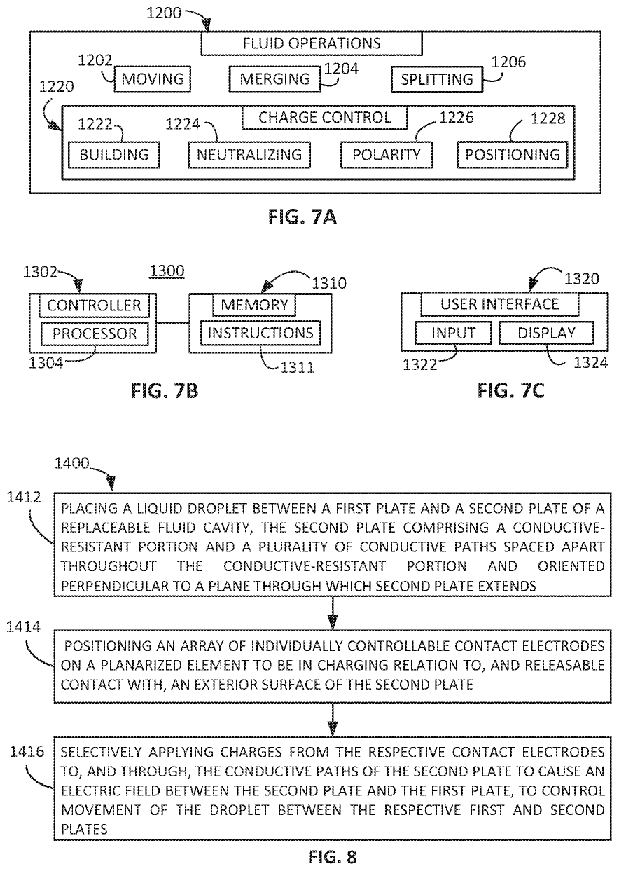

In some examples, such microfluidic operations to be performed via the consumable microfluidic receptacle 102 and an addressable electrode control element (e.g. 150 in FIGS. 1A-1B) may be implemented in association with a control portion, such as but not limited to control portion 1300 in FIG. 7B and/or in association with a fluid operations engine 1200 in FIG. 7A.

FIG. 2 is a diagram including an elevational view schematically representing an example microfluidic device 200. In some examples, the microfluidic device 200 comprises at least some of substantially the same features and attributes as the consumable microfluidic receptacle 102 in FIGS. 1A-1B. In particular, in some examples, the microfluidic receptacle 102 in FIGS. 1A-1B may comprise at least a portion of the example microfluidic device 200.

As shown in FIG. 2, the microfluidic device 200 comprises a housing 205 within which is formed an array 215 of interconnected passageways 219A, 219B, 219C, 219D, 219E, with each respective passageway being defined by a series of target positions 217. In some examples, the respective passageways 219A-219E are defined between a first plate (like first plate 110 in FIGS. 1A-1B) and a second plate (like second plate 120 in FIGS. 1A-1B), with each target position 217 corresponding to a target position (e.g. T1 or T2) shown in FIGS. 1A-1B at which a droplet (e.g. 130 in FIG. 1) may be positioned. In some examples, the length (e.g. D2 in FIG. 1A) of a target position (e.g. T1, T2) of a droplet may be commensurate with the length (X1) of an electrode 153 (FIG. 1A). Accordingly, in some examples, each target position 217 may comprise a length of about 50 micrometers to about 5000 micrometers (i.e. 5 millimeters), while in some examples the length may be about 100 micrometers to about 2500 micrometers. In some examples, the length may be about 250 micrometers to about 1500 micrometers. In some examples, the length may be about 1000 micrometers. Meanwhile, in some examples, each target position 217 may have a width commensurate with the length, such as the above-noted examples.

As previously noted in association with FIGS. 1A-1B, the respective target positions 217 and the passageways 219A-219E (of the consumable microfluidic receptacle 200 shown in the example of FIG. 2) do not include control electrodes for moving droplets 130. Rather, droplets 130 are moved through the various passageways 219A, 219B, 219B, 219D, 219E via pulling forces caused by applying charges from the individually controllable electrodes 153 of releasable contact, electrode control element 150, as previously described in association with FIGS. 1A-1B. Accordingly, via the use of such an externally-applied electric field, the droplet(s) 130 move through the passageways via pulling forces (e.g. electrowetting forces) without any on-board control electrodes lining the paths defined by the various passageways 219A-219E.

As further shown in FIG. 2, at least some of the respective target positions 217, such as at positions 221A, 221B, 223A, and/or 223B may comprise an inlet portion which can receive a droplet 130 to begin entry into the passageways 219A-219E to be subject to microfluidic operations such as moving, merging, splitting, etc. In some examples, some of the example positions 221A, 221B, 223A, 223B may comprise an outlet portion, from which fluid may be retrieved after certain microfluidic operations.

It will be understood that in some examples, the consumable microfluidic receptacle 200 of FIG. 2 may comprises features and attributes in addition to those described in association with FIGS. 1A-1B. For example, in some instances, prior to receiving droplets 130, the consumable microfluidic device 200 may comprise at least one fluid reservoir R at which various fluids (e.g. reagents, binders, etc.) may be stored and which may be released into at least one of the passageways 219A-219E. In some examples, release of such reagents or other materials may be caused by the same externally-caused pulling forces as previously described to movement droplet 130. Moreover, in some examples, at least some of the passageways 219A-219E may form or define a lateral assay flow device in which some reagents, etc. may already be present at various target positions 217 within a particular passageway (e.g. 219A-219E) such that upon movement of various droplets 130 relative to such target positions 217 may result in desired reactions to effect a lateral flow assay. However, in some examples, the consumable microfluidic receptacle 200 does not store any liquids on board, and any liquids on which microfluidic operations are to be performed are added, such as in the example inlet locations 221A, 221B, 223A, 223B, as previously described.

Via the externally-caused controlled movement of the respective droplets within the passageways 219A-219E, various microfluidic operations of moving, merging, splitting may be performed within consumable microfluidic receptacle 200 to cause desired reactions, etc. With this in mind, in some examples a portion of the consumable microfluidic receptacle 200 may comprise at least one sensor (represented by indicator S in FIG. 3A) to facilitate tracking the status and/or position of droplets within a consumable microfluidic receptacle, as well as for determining a chemical or biochemical result ensuing from the various microfluidic operations, such as merging, splitting, etc. In some such examples, such sensors may be incorporated into the first plate 110 (FIGS. 1A-1B) so as to not interfere with the deposit of charges, transport of charges, neutralization of charges, etc. occurring at or through the second plate 120 (FIGS. 1A-16). In some examples the sensor(s) may include external sensors, like optical sensors. In some such examples, such external sensors may be used to sense attributes of a fluid retrieved from an above-described outlet portion.

In some examples, such microfluidic operations to be performed via the consumable microfluidic receptacle 200 and an addressable electrode control element (e.g. 150 in FIGS. 1A-1B) may be implemented in association with a control portion, such as but not limited to control portion 1300 in FIG. 7B and/or in association with a fluid operations engine 1200 in FIG. 7A.

FIG. 3A is a diagram including a side view schematically representing an example arrangement 251 comprising a two-dimensional addressable electrode control element 250 in charging relation to a second plate 260 of a consumable microfluidic receptacle (e.g. 102 in FIG. 1A). In some examples, the addressable electrode control element 250 may comprise one example implementation of, and/or may comprise at least some of substantially the same features and attributes as, the addressable electrode control elements described in association with at least FIGS. 1A-2. Meanwhile, the second plate 260 (and associated consumable microfluidic receptacle) may comprise one example implementation of, and/or may comprise at least some of substantially the same features and attributes as, the second plate 120 (and associated consumable microfluidic receptacle 102) described in association with at least FIGS. 1A-2.

As shown in FIG. 3A, the example addressable electrode control element 250 comprises a two dimensional array 271 of individually controllable (e.g. addressable) electrodes 272. The array 271 comprises a size and a shape to cause controlled movement of droplets 130 to any one target position (e.g. 217 in FIG. 2) of a corresponding array 258 of target droplet positions (e.g. 217 in FIG. 2) implemented via the second plate 260 (of a consumable microfluidic receptacle). In some examples, at least some of the respective example addressable electrodes 272 of control element 250 may correspond to the example electrodes 153 shown in FIGS. 1A-1B, which may be operated to apply charges (of a desired first polarity or opposite second polarity) in order to build charges on an exterior surface 262 of second plate 260 (of a consumable microfluidic receptacle) to cause a desired direction of movement of a droplet along a passageway (e.g. 219A-219E in FIG. 2) within the consumable microfluidic receptacle. In some such examples, any one of the addressable electrodes 272 also may be operated in a charge neutralizing mode in which charges are emitted having a polarity (e.g. negative) opposite the polarity of the charges (e.g. positive) used to initiate an electrowetting movement of the liquid droplet 130.

Via the two-dimensional arrangement 251 shown in FIG. 3A, both the second plate 260 of the consumable microfluidic receptacle (e.g. 102) and the addressable electrode control element 250 remain stationary while the various respective electrodes 272 (of array 271) may be selectively operated (e.g. individually controlled) to control droplet movement for any or all of the target positions (e.g. 217 in FIG. 3A) of the second plate 260 (e.g. 120 in FIGS. 1A-1B) of the consumable microfluidic receptacle.

FIG. 3B is a diagram including a top view schematically representing an example two dimensional array 280 of individually controllable electrodes 282A-282E. In some examples, the array 280 comprises at least some of substantially the same features and attributes as, and/or comprises one example implementation of, the two-dimensional array 271 of electrodes 272 in FIG. 3A. While FIG. 3B depicts six different electrodes 282A-282E, it will be understood that the array 280 may comprise a fewer number or greater number of electrodes than shown in FIG. 3B.

As shown in FIG. 3B, each electrode 282A-282E comprises an irregular-shaped edge 284 such that the respective electrodes 282A-282E are spaced apart from each other by a distance S1 which forms a gap 285. In some such examples, the irregular-shaped edge 284 may comprise a zig-zag shape in which triangular-portions are aligned in a complementary manner. However, in some examples, the edges 284 of the respective electrodes 282A, 282B may comprise other shapes, such as a sinusoidal shape, rectangular shape, etc. in which the edge 284 of one electrode (e.g. 282B) fits in a complementary manner relative to an opposing edge 284 of an adjacent electrode (e.g. 282A).

In some examples, the array 280 of electrodes 282A-282E may be implemented within a control element (e.g. 250 in FIG. 3A) to cause electrowetting movement of a liquid droplet 290, as further shown in FIG. 3B. In some examples, the gap 285 may comprise a distance (S1) on the order of 50 to 75 micrometers, which may be associated with manufacturing attributes relating to the printed circuit board via which the array 280 of electrodes 282A-282E may be formed. In some examples, a width of the electrodes (e.g. 282A, 282B, etc.) may comprise on the order of 2 millimeters.

The irregular shape (e.g. zig-zag) of the edge 284 of the electrodes (e.g. 282A-282E) may help ensure a leading edge (e.g. edge 284 of electrode 282B) and a trailing edge (e.g. edge 284 of electrode 282A) both overlap with the droplet 290 being moved (e.g. directional arrow G). This overlap, enhanced by the irregular shaped edge 284, may facilitate the desired electrowetting movement from one electrode (e.g. 282A) to the next electrode (e.g. 282B), which is to actively pull the droplet onto electrode 282B. In particular, because a leading edge 291 of the droplet 290 is curved, a relatively small portion of the droplet 290 may overlap between the two adjacent electrodes 282A, 282B such that the full width of the droplet is not subject to the forces which might otherwise be applied to the droplet 290 if the entire droplet 290 extended across the full edge 284 of the electrode 282B attempting to pull the droplet 290 forward. In view of the situation, the irregular shaped edge 284 (e.g. zig-zag) may increase the extent (e.g. surface area) by which portions of the electrode (e.g. 282B) can exert the pulling force on the relatively small leading edge 291 of the droplet 290.

In some examples, the irregular shaped edge 284 of the respective electrodes 282A-282E may provide enhanced effectiveness in facilitating electrowetting movement for smaller droplets having a size (e.g. greatest cross-sectional dimension) on the order of 30-200 micrometers. In some examples, the size and shape of the gap 285 formed by the edges 284 of adjacent electrodes (e.g. 282A, 282B) may be uniform among all the respective electrodes (e.g. 282A-282E) of the array 280. However, in some examples, such spacing may be non-uniform.

FIG. 4 is a diagram including a side view schematically representing an example consumable microfluidic receptacle 300. In some examples, the example consumable microfluidic receptacle 300 may comprise, and/or be employed via, at least some of substantially the same features and attributes as the examples previously described in association with at least FIGS. 1A-3B. In some examples, microfluidic receptacle 300 may comprise a first coating 305 on interior surface 111 of first plate 110 and/or a second coating 307 on interior surface 121 of second plate 120, with such coatings arranged to facilitate controlled movement of droplets 130 through a passageway 119 defined between the respective plates 110, 120.

In some examples, at least one of the respective coatings 305, 307 may comprise a hydrophobic coating, and in some examples, at least one of the respective coatings 305, 307 may comprise a low contact angle hysteresis coating. In some examples, a low contact angle hysteresis coating may correspond to contact angle hysteresis of less than about 30, 29, 28, 27, 26, 25, 24, 23, 22, 21, or 20 degrees. In some examples, the contact angle hysteresis may comprise less than about 20, 19, 18, 17, 16, or 15 degrees. In some example implementations including coatings 305, 307, an oil filler is provided within the passageways 219A-219E, which may further enhance the effect of the coatings 305, 307. In some examples, the coating 305 and coating 307 may have respective thicknesses of D5, D6 on the order of one micrometer, but in some examples the thicknesses D5, D6 can be less than one micrometer, such as a few tens of nanometers. In some examples, the thicknesses can be greater than one micrometer, such as a few micrometers.

As further shown in FIG. 4, in some examples the consumable microfluidic receptacle 300 may comprise an electrically conductive layer 311, by which the first plate 110 may be electrically connected to a ground element 113. In some such examples, the electrically conductive layer 311 may comprise a material such an indium titanium oxide (ITO) which is transparent and may have a thickness D7 on the order of a few tens of nanometers. While not shown in at least FIGS. 1A-1B and FIGS. 5A-6D for illustrative simplicity, it will be understood that in some examples the electrically conductive layer 311 may form a portion of (or a coating on) the first plate (e.g. 110) in any one or all of the various example consumable microfluidic receptacles (of an example microfluidic device) of the present disclosure.

FIG. 5A is a diagram including a side view schematically representing an example arrangement 401 including an example consumable microfluidic receptacle 402. In some examples, the example consumable microfluidic receptacle 402 may comprise, and/or be employed via, at least some of substantially the same features and attributes as the example consumable microfluidic receptacles as previously described in association with at least FIGS. 1A-4, except with a second plate 420 comprising different first and second portions 424, 426 and/or except with a spacer element(s) 405. Accordingly, in some examples, both of the first and second portions 424, 426 comprise at least some of substantially the same features and attributes of anisotropic conductivity as in the examples of at least FIGS. 1A-1B.

In particular, as shown in FIG. 5A, the second plate 420 comprises a first portion 424 which is rigid and a second portion 426 which is made of a compliant and/or resilient material. In some such examples, the second portion 426 may sometimes be referred to as being soft in contrast to the rigid first portion 424. In some such examples, the compliant second portion 426 is adapted to at least partially conform to the size and shape of the electrodes 153 of the electrode control element 150, as shown in FIG. 5A. It will be understood that the body portion of the electrode control element 150, which supports electrodes 153, is omitted from FIG. 5A for illustrative simplicity. Accordingly, via this arrangement, the compliant second portion 426 may facilitate robust engagement of the electrodes 153 relative to the second plate 420 upon releasable contact of the electrode control element 150 relative to an exterior surface 422 (like 122 in FIGS. 1A-1B) of the second plate 420. In addition to facilitating a robust electrical interface of the electrodes 153 relative to the second plate 420, the compliant second portion 426 also may help resist any potential, unintended lateral motion of the electrodes 153 relative to the second plate 420.

In some examples, the first portion 424 may comprise a thickness (D8) of about 20 micrometers to about 160 micrometers, a thickness (D8) of about 25 micrometers to about 155 micrometers, or a thickness (D8) of about 30 micrometers to about 150 micrometers.

In some examples, the second portion 426 may comprise a thickness (D9) greater than a thickness (D8) of the first portion 424, a thickness (D9) substantially the same as the thickness (D8) of the first portion 424, or a thickness (D9) less than the thickness (D8) of the first portion 424. The selection of the thickness (D9) relative to thickness (D8) may be based on several factors such as, but not limited to, the flatness of exterior surface 122 of second plate 420 (e.g. 120 in FIGS. 1A-1B) and of the top surface 151 of control element 150 (which may include the opt surface of electrodes 153).

In some examples in which the second portion 426 comprises a thickness (D9) less than the thickness (D8) of the first portion 424, the second portion 426 may comprise a thickness (D9) of about 10 micrometers to about 30 micrometers, a thickness (D9) of about 15 to about 25 micrometers, or a thickness (D9) of about 20 micrometers.

In some examples, the compliant second portion 426 may have a Shore A durometer hardness of lower than 30.

In some examples, and as previously noted in association with FIGS. 1A-1B, the consumable microfluidic receptacle 402 may comprise spacer element(s) 405 extending between the first and second plates 110, 420 to maintain the spacing between the respective plates 110, 420 and/or to provide structural integrity to the consumable microfluidic receptacle 402. In some such examples, the spacer element(s) 405 may be formed as part of process of molding the consumable microfluidic receptacle 402 (including the respective plates 110 and/or 420). It will be further understood that the spacer element(s) 405 and fluid passageways (e.g. 219A-219E in FIG. 2) are positioned relative to each other so that spacer element(s) 405 do not impede intended movement of fluid droplet(s) 130. It will be understood that such spacer element(s) 405 may be implemented in any or all of the various example consumable microfluidic receptacles of the present disclosure.

FIG. 5B is a diagram including a side view schematically representing an example arrangement 501 including an example consumable microfluidic receptacle 502. In some examples, the example consumable microfluidic receptacle 502 may comprise, and/or be employed via, at least some of substantially the same features and attributes as the example consumable microfluidic receptacles as previously described in association with at least FIG. 1A-5A, except with the second plate 420 comprising a second portion 526 which lacks anisotropic conductivity and which comprises a conductive adhesive material. The compliant material of second portion 526 may facilitate robust engagement of the electrodes 153 in releasable contact against the second plate 420 by the compliant material at least partially conforming to the size and shape of electrodes 153. In some examples, the second portion 526 may comprise a gel-like material.

In some such examples, the second portion 526 may comprise a conductivity on the order of 18M Ohm-cm (e.g. 16.5, 17, 17.5, 18, 18.5, 19, 19.5 Ohm-cm) and a relative permittivity on the order of 80 (e.g. 70, 75, 80, 85, 90). In some such examples, this high conductivity may facilitate rapid transfer of charges from electrodes 153 to the conductive elements 134 in the first portion 424 of second plate 420, which may further enhance rapid charge transfer (e.g. transport) to the interior surface 121 of the second plate 420.

In some examples, the second portion 526 may comprise a thickness (D10) on the order of 1-2 mils (e.g. thousandth of an inch).

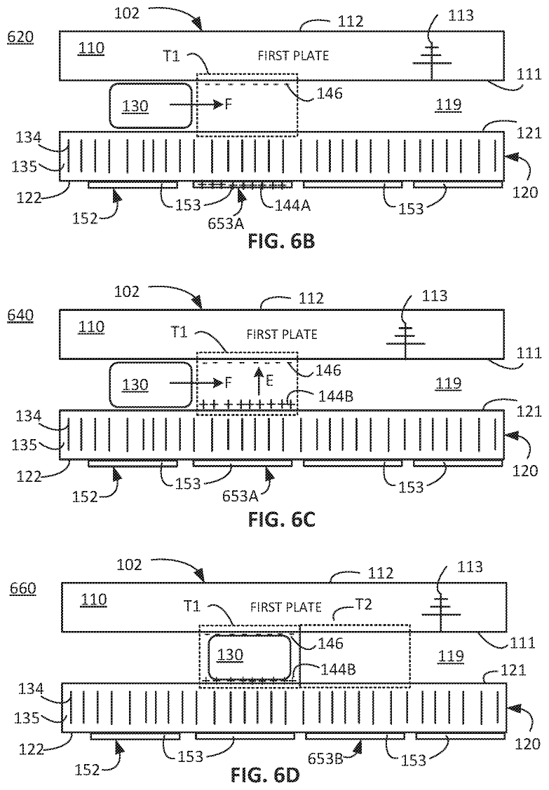

FIG. 6A-6D are a series of diagrams, which together, schematically represent the application of charges from an electrode control element 150, in releasable contact against a consumable microfluidic receptacle 102 of example arrangement 601, to control movement of a liquid droplet within the consumable microfluidic receptacle. In some examples, the example arrangement 601 including electrode control element 150 and/or consumable microfluidic receptacle 102 may comprise at least some of substantially the same features and attributes as in the previously described examples of the present disclosure in FIGS. 1-5B. While FIG. 1B schematically represents at least some of substantially the same actions and effects as shown in FIGS. 6A-6D, FIGS. 6A-6D provide simpler schematic representations of the sequence of actions and/or effects.

For illustrative simplicity, just the electrodes 153 of the electrode control element 150 will be depicted throughout FIGS. 6A-6D.

FIG. 6A schematically represents an initial point at which electrodes 153 (of an electrode control element 150) have been brought into releasable contact against the second plate 120 of a consumable microfluidic receptacle 102, but prior to any external application of charges by the electrode control element 150.

In order to initiate an intended movement of droplet 130 to target position T1, charges 144A are directed from a selected electrode 153 (e.g. 153A) onto exterior surface 122 of second plate 120 of the consumable microfluidic receptacle 102, as shown in FIG. 6B.

As further shown in FIG. 6B, upon the presence of charges 144A (e.g. positive) at exterior surface 122 of second plate 120, counter charges (e.g. negative) will develop at the interior surface 111 of grounded plate 110, such as to minimize the electric field E outside the effective capacitor formed between the second plate 120 and the first plate 110.

FIG. 6C reflects the presence of charges 144B at interior surface 121 of second plate 120 after their transport from exterior surface 122 (as deposited charges 144A), via the conductive elements 134, through the conductive-resistant medium 135 of the second plate 120. As further shown in FIG. 6C, the electric field E exerts a pulling force (F) on the droplet 130, in the manner previously explained in association with at least FIGS. 1A-1B, to pull droplet 130 into target position T1.

FIG. 6D represents a completion of the droplet 130 being pulled (e.g. moving) into the target position T1, as well as one potential next target position, as shown in dashed lines T2. After such movement of the droplet 130, the previously selected electrode 653A may be set to ground, thereby facilitating neutralization of the charges 144B and counter charges 146 at the respective interior surfaces 121, 111 of the respective plates 110, 120. As noted in at least some previous examples of the present disclosure, some of the charges (e.g. 144B, 146) will have already dissipated (e.g. become discharged) over time for other reasons, such as via the droplet 130, via the second plate 120, etc.

As further understood from at least FIG. 6D, upon an input to electrode control element (e.g. 150 in FIGS. 1A-1B) to cause movement of the droplet 130 to the next target position T2, charges may be applied from a next selected electrode 653B to the second plate 120 in a manner substantially the same as depicted in FIG. 6B. Thereafter, the overall arrangement of the second plate 120 and grounded first plate 110 cause the same behavior and effects of the charges 144B, counter charges 146, pulling force F, movement of droplet 130, etc. as described previously in association with at least FIGS. 6A-6D.

FIG. 7A is a block diagram schematically representing an example fluid operations engine 1200. In some examples, the fluid operations engine 1200 may form part of a control portion 1300, as later described in association with at least FIG. 7B, such as but not limited to comprising at least part of the instructions 1311. In some examples, the fluid operations engine 1200 may be used to implement at least some of the various example devices and/or example methods of the present disclosure as previously described in association with FIGS. 1-6D and/or as later described in association with FIGS. 7B-8. In some examples, the fluid operations engine 1200 (FIG. 7A) and/or control portion 1300 (FIG. 7B) may form part of, and/or be in communication with, an addressable electrode control array and/or a consumable microfluidic receptacle, such as the devices and methods described in association with at least FIGS. 1-6D.

As shown in FIG. 7A, in some examples the fluid operations engine 1200 may comprise a moving function 1202, a merging function 1204, and/or a splitting function 1206, which may track and/or control manipulation of droplets within a microfluidic device, such as moving, merging, and/or splitting, respectively.

In some examples, the fluid operations engine 1200 may comprise a electrode control engine 1220 to track and/or control parameters associated with operation of an addressable electrode array (including individually controllable electrodes) to build charges (parameter 1222) or neutralize charges (parameter 1224) on a consumable microfluidic receptacle (of a microfluidic device), as well as to track and/or control the polarity (parameter 1224) of such charges. In some examples, a positioning parameter (1226) of the electrode control engine 1220 is to track and/or control positioning (1226) of an addressable electrode array to establish releasable contact against a consumable microfluidic receptacle to implement such building or neutralizing of charges. In some such examples, the positioning parameter 1226 may be implemented with frame 133 as previously described in association with at least FIGS. 1A-1B.

It will be understood that various functions and parameters of fluid operations engine 1200 may be operated interdependently and/or in coordination with each other, in at least some examples.

FIG. 7B is a block diagram schematically representing an example control portion 1300. In some examples, control portion 1300 provides one example implementation of a control portion forming a part of, implementing, and/or generally managing the example microfluidic arrangements, addressable electrode control elements, consumable microfluidic receptacles, microfluidic operations, control portion, instructions, engines, functions, parameters, and/or methods, as described throughout examples of the present disclosure in association with FIGS. 1A-7A and 7C-8. In some examples, control portion 1300 includes a controller 1302 and a memory 1310. In general terms, controller 1302 of control portion 1300 comprises at least one processor 504 and associated memories. The controller 1302 is electrically couplable to, and in communication with, memory 1310 to generate control signals to direct operation of at least some of the example microfluidic arrangements, addressable electrode control elements, consumable microfluidic receptacles, microfluidic operations, control portion, instructions, engines, functions, parameters, and/or methods, as described throughout examples of the present disclosure. In some examples, these generated control signals include, but are not limited to, employing instructions 1311 stored in memory 1310 to at least direct and manage microfluidic operations in the manner described in at least some examples of the present disclosure. In some instances, the controller 1302 or control portion 1300 may sometimes be referred to as being programmed to perform the above-identified actions, functions, etc.

In response to or based upon commands received via a user interface (e.g. user interface 1320 in FIG. 7C) and/or via machine readable instructions, controller 1302 generates control signals as described above in accordance with at least some of the examples of the present disclosure. In some examples, controller 1302 is embodied in a general purpose computing device while in some examples, controller 1302 is incorporated into or associated with at least some of the example microfluidic arrangements, addressable electrode control elements, consumable microfluidic receptacles, microfluidic operations, control portion, instructions, engines, functions, parameters, and/or methods, etc. as described throughout examples of the present disclosure.

For purposes of this application, in reference to the controller 1302, the term “processor” shall mean a presently developed or future developed processor (or processing resources) that executes machine readable instructions contained in a memory or that includes circuitry to perform computations. In some examples, execution of the machine readable instructions, such as those provided via memory 1310 of control portion 1300 cause the processor to perform the above-identified actions, such as operating controller 1302 to implement microfluidic operations via the various example implementations as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1310. The machine readable instructions may include a sequence of instructions, a processor-executable machine learning model, or the like. In some examples, memory 1310 comprises a computer readable tangible medium providing non-volatile storage of the machine readable instructions executable by a process of controller 1302. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 1302 may be embodied as part of at least one application-specific integrated circuit (ASIC), at least one field-programmable gate array (FPGA), and/or the like. In at least some examples, the controller 1302 is not limited to any specific combination of hardware circuitry and machine readable instructions, nor limited to any particular source for the machine readable instructions executed by the controller 1302.

In some examples, control portion 1300 may be entirely implemented within or by a stand-alone device.

In some examples, the control portion 1300 may be partially implemented in one of the example microfluidic arrangements (e.g. addressable electrode control element and/or consumable microfluidic receptacle) and partially implemented in a computing resource separate from, and independent of, the example microfluidic arrangements (e.g. addressable electrode control element and/or consumable microfluidic receptacle) but in communication with the example microfluidic arrangements. For instance, in some examples control portion 1300 may be implemented via a server accessible via the cloud and/or other network pathways. In some examples, the control portion 1300 may be distributed or apportioned among multiple devices or resources such as among a server, an example microfluidic arrangement, and/or a user interface.

In some examples, control portion 1300 includes, and/or is in communication with, a user interface 1320 as shown in FIG. 7C. In some examples, user interface 1320 comprises a user interface or other display that provides for the simultaneous display, activation, and/or operation of at least some of the example microfluidic arrangements, addressable electrode control elements, consumable microfluidic receptacles, microfluidic operations, control portion, instructions, engines, functions, parameters, and/or methods, etc., as described in association with FIGS. 1A-7B and 8. In some examples, at least some portions or aspects of the user interface 1320 are provided via a graphical user interface (GUI), and may comprise a display 1324 and input 1322.

FIG. 8 is a flow diagram of an example method 1400. In some examples, method 1400 may be performed via at least some of the example microfluidic arrangements, addressable electrode control elements, consumable microfluidic receptacles, microfluidic operations, instructions, control portions, engines, functions, parameters, and/or methods, etc. as previously described in association with at least FIGS. 1A-7C. In some examples, method 1400 may be performed via at least some example microfluidic arrangements, addressable electrode control elements, consumable microfluidic receptacles, microfluidic operations, instructions, control portions, engines, functions, parameters, and/or methods, etc. other than those previously described in association with at least FIGS. 1A-7C.

As shown at 1412 in FIG. 8, in some examples method 1400 comprises placing a liquid droplet between a first plate and a second plate of a replaceable fluid cavity, the second plate comprising a conductive-resistant portion and a plurality of conductive paths spaced apart throughout the conductive-resistant portion and oriented perpendicular to a plane through which second plate extends. In some examples, the conductive-resistant portion comprises a bulk resistivity of between on the order of 10¹¹ and on the order of 10¹⁶ Ohm-cm. In some examples, at 1412 the method 1400 also may be considered as receiving a liquid droplet between the first plate and the second plate. As further shown at 1414 in FIG. 8, in some examples method 1400 comprises positioning an array of individually addressable contact electrodes on a planarized element to be in charging relation to, and releasable contact with, a first exterior surface of the second plate. As further shown at 1416 in FIG. 8, in some examples method 1400 comprise selectively applying charges from the respective contact electrodes to, and through, the conductive paths of the second plate to cause an electric field between the second plate and the first plate, to control movement of the droplet through a passageway between the respective first and second plates. In some examples, the applied electric field causes electrowetting-based movement of the liquid droplet.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A consumable microfluidic receptacle comprising:
a first sheet electrically connectable to a ground element; and
a second sheet spaced apart from the first sheet, the microfluidic receptacle to receive a liquid droplet between the first and second sheets, the second sheet including an exterior surface portion to receive releasable contact from an array of individually controllable electrodes of an electrode control element to produce an electric field from the second sheet to the first sheet to selectively pull the liquid droplet through the microfluidic receptacle via electrowetting forces,
wherein the second sheet comprises a conductive-resistance matrix and a plurality of conductive paths spaced apart throughout the matrix and oriented perpendicular to a plane through which the second sheet extends.

2. The consumable microfluidic receptacle of claim 1, wherein the conductive-resistant matrix comprises a bulk resistivity between on the order of 10¹¹ and on the order of 10¹⁶ Ohm-cm.

3. The consumable microfluidic receptacle of claim 1, wherein the second sheet comprises a thickness between about 50 to about 1000 micrometers and comprises a relative permittivity perpendicular to the plane greater than about 20.

4. The consumable microfluidic receptacle of claim 1, wherein the second sheet comprises a rigid first portion and a compliant second portion, the second portion including the exterior surface portion of the second sheet and the first portion including an interior surface portion of the second sheet which faces the first sheet.

5. The consumable microfluidic receptacle of claim 1, wherein the second sheet comprises a rigid portion, and wherein the exterior surface portion of the second sheet further comprises a conductive, adhesive compliant material.

6. The consumable microfluidic receptacle of claim 5, wherein the adhesive compliant material of the second portion of the third sheet comprises a conductivity on the order of about 18M Ohm-cm and a relative permittivity on the order of about 80.

7. The consumable microfluidic receptacle of claim 1, wherein an interior surface of each of the first sheet and of the second sheet comprises an interior surface comprising at least one of:
a contact angle hysteresis of less than about 20 degrees; and
a hydrophobic coating.

8. The consumable fluid receptacle of claim 1, wherein each conductive path includes an elongate pattern of field-aligned, conductive particles and each elongate pattern is sized and shaped to receive charges at the exterior surface of the conductive-resistant matrix.

9. A digital microfluidic assembly comprising:
an electrode control element, the electrode control element comprising an array of individually controllable electrodes of a printed circuit board; and
a support to releasably support a consumable microfluidic receptacle in releasable contact against the array of individually controllable electrodes to receive charges on a first anisotropic conductivity portion of the consumable microfluidic receptacle to cause an electric field within the consumable microfluidic receptacle to induce electrowetting movement of a liquid droplet within the consumable microfluidic receptacle.

10. The digital microfluidic assembly of claim 9, wherein the consumable microfluidic receptacle comprises:
a first plate electrically connectable to a ground element; and
the first anisotropic conductivity portion arranged as a second plate spaced apart from the first plate, the microfluidic receptacle to receive the liquid droplet between the first and second plates, the second plate including an exterior surface, wherein the second plate comprises a plurality of conductive paths spaced apart throughout the second plate and oriented perpendicular to a plane through which second plate extends.

11. The digital microfluidic assembly of claim 10, wherein the second plate comprises a thickness between about 50 to about 300 micrometers, and wherein the first anisotropic conductivity portion of the second plate comprises a bulk resistivity of between on the order of 10¹¹ and on the order of 10¹⁶ Ohm-cm.

12. The digital microfluidic assembly of claim 10, wherein the second plate comprises a rigid first portion and a compliant second portion, the second portion including the exterior surface of the second plate and the first portion including an interior surface of the second plate which faces the first sheet.

13. A method comprising:
placing a liquid droplet between a first plate and a second plate of a replaceable fluid cavity, the second plate comprising a conductive-resistant portion comprising a bulk resistance of between on the order of 10¹¹ and on the order of 10¹⁶ Ohm-cm and a plurality of conductive paths spaced apart throughout the conductive-resistant portion with each conductive path oriented perpendicular to a plane through which second plate extends;
positioning an array of individually controllable contact electrodes on a planarized element to be in charging relation to, and releasable contact with, an exterior surface portion of the second plate; and
selectively applying charges from the respective contact electrodes to, and through, the conductive paths of the second plate to cause an electric field between the second plate and the first plate, to control electrowetting movement of the droplet through a passageway between the respective first and second plates.

14. The method of claim 13, comprising:
arranging the second plate to comprise a thickness between about 30 micrometers to about 1000 micrometers and a relative permittivity greater than about 20.

15. The method of claim 13, comprising
arranging the second plate as a rigid first portion and a compliant second portion, the compliant second portion defining the exterior surface portion of the second plate.
